(19) United States
(12) Patent Application Publication
(10) Pub. No.: US 2003/0022567 A1
(43) Pub. Date: Jan. 30, 2003

(54) Geotextiles having excellent transmissivities under high loading pressures

(76) Inventors: Young Sik Kim, Seoul (KR); Han Yong Jeon, Gwangju-city (KR)

Correspondence Address: McGuireWoods, 1750 Tysons Boulevard, Suite 1800, Tysons Corner, McLean, VA, 22102-4215, US

(21) Appl. No.: 10/117,135

(22) Filed: Apr. 8, 2002

(30) Foreign Application Priority Data
Jun. 15, 2001 (KR) 20-2001-0018001

(51) Int. Cl. B32B 5/26

(52) U.S. Cl. 442/35; 442/381; 442/268

(57) ABSTRACT

Disclosed is geotextiles for use on the upper and the lower side of geomembranes used for shielding leakage of the leachates in sanitary landfills. The geotextiles are formed by laminating plural fiber webs composed of fibers with a fineness of 20 to 1000 deniers. Here, non-woven fabrics 1 with a weight of 300 to 2000 g/m² are disposed on and bonded to both sides or any one side of the non-woven fabrics or woven fabrics 2 and 2′ with a weight of 100 to 1500 g/m² consisting of fibers with a fineness of 3 to 15 deniers by a needle punching process or heat treatment and resin treatment process in such a way that an outer non-woven fabric or woven fabrics 2 and 2′ are laminated in a single layer or double layers. The geotextiles have advantages in that their transmissivities are good under high loading pressures, stability of slopes of sanitary landfills is secured and the geomembranes are protected under the reclamation loading pressure, as well as production cost and construction cost are low in comparison with those of the conventional geosynthetics.

### BACKGROUND OF THE INVENTION

1. Field of the Invention

The present invention relates, in general, to geotextiles having excellent transmissivities under high loading pressures and, in particular, to geotextiles having excellent transmissivities under high loading pressures which can protect geomembranes, designed to shield against the leakage of leachates due to the pressure of loaded wastes and external impact, which will ensure the smooth drainage of leachates from the wastes which is necessary in order to maintain the slope of sanitary landfills, the geomembranes being installed when the sanitary landfills are constructed.

2. Description of the Prior Art

In the beginning of the 1970's, geosynthetics were mostly used in preventing the erosion of earth and sand and for filtering earth and sand. Applications of geosynthetics have been extended to include the separation and reinforcement of the ground, and drainage of leachates. In recent years, the geosynthetics have been further applied in waterproofing, prevention of ground cracks, protection of the structural integrity of constructions in the ground, and absorption of impact. On the use of geosynthetic fiber materials in civil engineering fields, many studies have been done on the use of geosynthetics in sanitary landfills to prevent soil pollution from leachates.

Leachates are the liquids formed by the interaction of reclaimed wastes with moisture from rain or snow. Leachates are the major cause of soil and underground water pollution. To prevent the above ground pollution causing the leachates, geosynthetics have been used for shielding and draining leachates in the sanitary landfills since the middle of 1980's.

Because of the antagonism and antipathy for the equipment such as waste reclaiming equipments (NIMBY not in my back yard) and serious pollution problems throughout the world, the demands for stable sanitary landfills grows, and standards for waste reclaiming equipments have been reinforced.

In some countries, protective materials are located on the upper and lower sides of the geomembranes, and geosynthetic drainage layers are located on the upper and the lower sides of the geomembranes which are positioned on the slope of the sanitary landfills. Materials useful in producing the above structure are very limitedly selected when conventional products are used. Furthermore, the combination of two or more geotextile products or geotextile related composite products is required for application for the construction of sanitary landfills because the sanitary requirements described in laws cannot be met by use of only one product. However, the use of different geotextile products in combination or geotextile related composite products makes the installation cost high, the installation period long, and the quality of products and stability of construction poor.

Therefore, recently, the compacted clay layer or compacted clay mineral-mixed soil layer with transmissivity of 10⁻⁷ cm/sec or lower could be set on the bottom of the sanitary landfills, the geomembranes are set on the clay layer, and the drainage layers for leachates collections made of materials such as sand of transmissivity, 10⁻² cm/sec or higher are set on the geomembranes.

To protect the geomembranes under the load of reclaimed wastes and the drainage layers for leachates collections, protective layers such as geocomposites and non-woven geotextiles are positioned between the geomembranes and the drainage layers for leachates collections.

However, the geocomposites having poor puncture resistance, are not suitable to use as materials for preventing the breakdown of the geomembranes because crushed stone ballasts (thickness: 50 mm or thicker) are used as materials for the drainage layers for leachates collections in most sanitary landfills. Therefore, it is preferable to use non-woven geotextiles having the proper thickness. General standards for weights of non-woven geotextiles established according to the reclamation height of the sanitary landfills, i.e. weights of non-woven fabric geotextiles determined according to the reclamation height of sanitary landfills when crushed stones 50 mm are used as materials for the drainage layers for leachates collections, are shown in Table 1, below.

TABLE 1

| Reclamation height (m) | 10 | 15 | 20 | 30 | 40 |
|---|---|---|---|---|---|
| Weight of non-woven fabric | 70 | 100 | 150 | 200 | 270 |
| (g/m²) | 0 | 0 | 0 | 0 | 0 |

### SUMMARY OF THE INVENTION

Therefore, it is an objective of the present invention to provide the geotextiles having excellent transmissivities, which can protect the geomembranes and secure the stability of the slope of sanitary landfills when the sanitary landfills are constructed.

Generally, geosynthetic clay liners (GCL), i.e. the swollen soil liners, are set on the bottom of the slope of the sanitary landfills, the geomembranes are set on GCL, and the geosynthetic drainage layers made of materials such as geocomposites, geonets, and non-woven geotextiles are set on the geomembranes. The geosynthetic drainage layers, at this point, should have excellent transmissivities under the applied loads.

### BRIEF DESCRIPTION OF THE DRAWINGS

The above and other objects, features and other advantages of the present invention will be more clearly understood from the following detailed description taken in conjunction with the accompanying drawings, in which:

FIG. 1 schematically illustrates the structure of the geotextiles according to the present invention;

FIG. 2 illustrates the embodiment of the present invention;

FIGS. 3 and 4 illustrate other embodiments of the present invention, respectively.

### DETAILED DESCRIPTION OF THE INVENTION

Based on the present invention, the above objective can be accomplished by the provision of geotextiles having excellent transmissivities under high loading pressures, which consist of non-woven fabrics from 300 to 2000 g/m² in weight formed by horizontally laminating plural fiber webs consisting of fibers with a fineness of 20 to 1000 deniers.

The present invention may be understood more readily with reference to the following detailed description of the preferred embodiments of the invention and the figures.

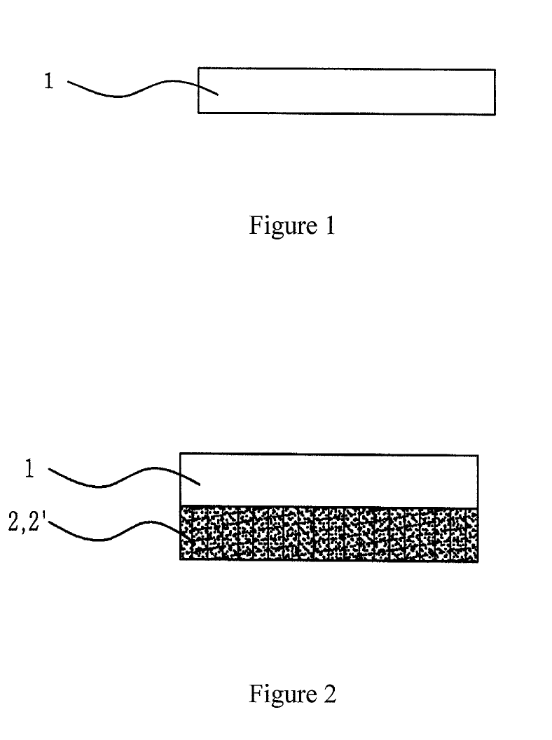

With reference to FIG. 1, non-woven fabrics 1 of the present invention are formed by horizontally laminating plural fiber webs composed of fibers with a fineness of 20 to 1000 deniers. The proper fineness of the fibers lies within the range of 20 to 1000 deniers, and weight of the non-woven fabrics 1 ranges from 300 to 2000 g/m². For example, when the fineness of the non-woven fabrics is less than 20 deniers, it is difficult to secure sufficient hydraulic permeability. On the other hand, when the fineness is more than 1000 deniers, there are various problems in laminating webs and producing the geotextiles. The non-woven fabrics 1 can have excellent transmissivities under high loading pressures when the fineness and the weight are within the above preferable ranges.

Examples of the fibers constituting the non-woven fabrics 1 include natural fibers, synthetic fibers, regenerated fibers, and mixtures thereof. Fibers having high chemical resistance to the leachates are preferable. In particular, polypropylene fibers are useful in the present invention.

Additionally, it is preferable to use the needle punching or free punching process to form the non-woven fabrics 1.

Referring to FIG. 2, the geotextiles are illustrated, in which outer woven fabrics or non-woven fabrics 2 are bonded to any one side of the non-woven fabrics 1 and outer woven fabrics or non-woven fabrics 2′ are bonded to the other side of the non-woven fabrics 1.

The outer woven fabrics or non-woven fabrics 2 and 2′ layers have the tensile strength and puncture resistance required to protect the geomembranes and secure the stability of the slope of the sanitary landfills to the geotextiles. The outer layers 2 and 2′ preferably consist of fibers with a fineness of 3 to 15 deniers. For example, when the fineness of fibers consisting of the outer layer deviates from the range of 3 to 15 deniers, the tensile force and tenacity of the fibers may be reduced. If the outer layer is non-woven fabrics, it is preferable to use non-woven fabrics 2 and 2′, which have been subjected to the needle punching process. On the other hand, if the outer layer is woven fabric, the net form textiles are useful in the present invention.

When the outer layer is non-woven fabric, it is preferable that non-woven fabrics 1 are bonded to non-woven fabrics 2 and 2′ by a needle punching process, because fibers are three-dimensionally bonded to each other by the needle punching process and so the binding forces between fibers are increased, thereby creating high tensile force and puncture resistance in the geotextiles. When the weight of the non-woven fabrics is in the range of 100 to 1500 g/m², the geotextiles have a tensile force sufficient to be used in the sanitary landfills.

Illustrating, but non-limiting examples of fibers, which compose the non-woven fabrics 2 and 2′ forming the outer layer, may include polypropylene and polyester.

A better understanding of the present invention may be obtained in light of the following examples which are set forth to illustrate, but are not to be construed to limit the present invention.

### EXAMPLE 1

Webs consisting of polypropylene fibers with a fineness of 60 deniers were horizontally laminated and free punched to create non-woven fabrics 1 with a weight of 2000 g/m². The transmissivities of the geotextiles thus prepared were measured under loading pressures of 10 to 400 kPa by ASTM D 4716 process. Results are described in table 2.

### EXAMPLE 2

Webs consisting of polypropylene fibers with a fineness of 40 deniers were horizontally laminated and free punched to create non-woven fabrics 1 with a weight of 1000 g/m². In addition, webs composed of polypropylene fibers with a fineness of 10 deniers were provided and outer non-woven fabrics 2 and 2′ with a weight of 300 g/m² were prepared. The outer non-woven fabrics 2 and 2′ were then bonded to both sides of the non-woven fabrics 1 using a needle punching process. Transmissivities of the geotextiles thus produced were measured under loading pressures of 10 to 400 kPa by ASTM D 4716 process. Results are described in table 2.

### EXAMPLE 3

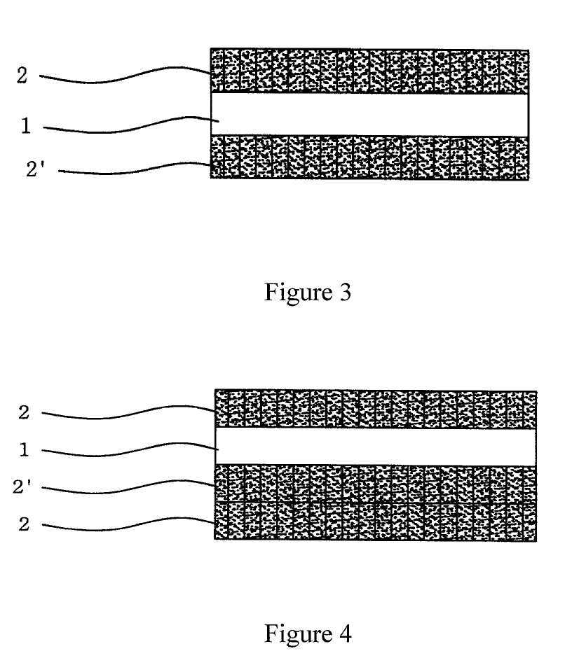

Webs consisting of polypropylene fibers with the fineness of 60 deniers were horizontally laminated to prepare non-woven fabrics 1 with the weight of 1000 g/m², as shown in FIG. 3. In addition, webs composed of polypropylene fibers with the fineness of 10 deniers were prepared and free punched to provide outer non-woven fabrics 2 and 2′ with the weight of 300 g/m². The outer non-woven fabrics 2 and 2′ were then bonded to both sides of the non-woven fabrics 1 using the needle punching process to produce the geotextiles. Transmissivities of the geotextiles thus produced were measured under the loading pressures of 10 to 400 kPa by ASTM D 4716 process. Results are described in table 2.

### EXAMPLE 4

Webs composed of polypropylene fibers with the fineness of 60 deniers were horizontally laminated to prepare non-woven fabrics 1 with the weight of 1000 g/m², as shown in FIG. 4. In addition, webs composed of polypropylene fibers with the fineness of 10 deniers were prepared and free punched to provide the outer non-woven fabrics 2 and 2′ with a weight of 700 g/m. The outer non-woven fabrics 2 and 2′ were then bonded to both sides of the non-woven fabrics 1 using the needle punching process in such a way as to bond two outer non-woven fabrics to any one side of the non-woven fabrics 1 and one outer non-woven fabric is bonded to the other side, thereby producing the geotextiles. Transmissivities of the geotextiles thus produced were measured under the loading pressures of 10 to 400 kPa by ASTM D 4716 process. Results are described in table 2.

### EXAMPLE 5

Polypropylene fiber-based net form textiles were bonded to both sides of the non-woven fabrics 1 of example 1 to produce geotextiles. Transmissivities of the geotextiles thus produced were measured under the loading pressures of 10 to 400 kPa by ASTM D 4716 process. Results are described in table 2.

TABLE 2

Transmissivities (m²/sec)

| | 10 kPa | 100 kPa | 200 kPa | 400 kPa |
|---|---|---|---|---|
| Example 1 | 3.1 × 10⁻⁴ | 2.0 × 10⁻⁴ | 1.1 × 10⁻⁴ | 8.6 × 10⁻⁵ |
| Example 2 | 2.1 × 10⁻⁴ | 1.1 × 10⁻⁴ | 7.8 × 10⁻⁵ | 5.0 × 10⁻⁵ |
| Example 3 | 2.4 × 10⁻⁴ | 1.3 × 10⁻⁴ | 8.0 × 10⁻⁵ | 5.6 × 10⁻⁵ |
| Example 4 | 2.7 × 10⁻⁴ | 1.4 × 10⁻⁴ | 8.1 × 10⁻⁵ | 6.1 × 10⁻⁵ |
| Example 5 | 2.9 × 10⁻⁴ | 1.9 × 10⁻⁴ | 9.8 × 10⁻⁵ | 7.5 × 10⁻⁵ |

As described above, the geotextiles of the present invention have advantages in that their transmissivities are good under high loading pressures, so that can serve as stabilizers of slopes of sanitary landfills, sufficiently protect geomembranes, and have low production cost.

It will be obvious to those skilled in the art that the geotextiles of the present invention are not limited to use in sanitary landfills; they may of course be applied with equal utility to the construction industry where geosynthetics for drainage, separation, filtration, and reinforcement are required. Many modifications and variations of the present invention are possible in light of the above teachings. Therefore, it is to be understood that within the scope of the appended claims, the invention may be practiced otherwise than as specifically described.

What is claimed is:

1. Geotextiles having excellent transmissivities under high loading pressures, which consist of non-woven fabrics of 300 to 2000 g/m² in weight, said fabrics being formed by horizontally laminating plural fiber webs composed of fibers with a fineness of 20 to 1000 deniers.

2. The geotextiles according to the claim 1, wherein the non-woven fabric has a woven fabric or an outer non-woven fabric bonded to each of its sides.

3. The geotextiles according to the claim 2, wherein the outer non-woven fabrics bonded to one side or both sides of the non-woven fabrics range, in weight per area, from 100 to 1500 g/m².

4. The geotextiles according to the claim 2, wherein the outer woven fabrics bonded to one side or both sides of the non-woven fabrics form a net structure.

5. The geotextiles according to the claim 1, wherein the woven fabrics or the outer non-woven fabrics are bonded to one side of the non-woven fabrics.

6. The geotextiles according to the claim 1, wherein the outer non-woven fabrics are bonded to one side of the non-woven fabrics, and other woven fabrics and outer non-woven fabrics are bonded to the other side of the non-woven fabrics.
